(19) United States
(12) Patent Application Publication
(10) Pub. No.: US 2016/0297259 A1
(43) Pub. Date: Oct. 13, 2016

(54) IMPROVED NOISE-REDUCING DEVICE FOR TIRE

(71) Applicants: COMPAGNIE GENERALE DES ETA- BLISSEMENTS MICHELIN, Clermont-Ferrand (FR); MICHELIN RECHERCHE ET TECHNIQUE S.A, Granges-Paccot (CH)

(72) Inventors: Frederic Bourgeois, Clermont-Ferrand (FR); Francois-Xavier BRUNEAU, Clermont-Ferrand (FR); Olivier MUHLHOFF, Clermont-Ferrand (FR)

(73) Assignees: COMPAGNIE GENERALE DES ETA- BLISSEMENTS MICHELIN, Clermont-Ferrand (FR); MICHELIN RECHERCHE ET TECHNIQUE S.A, Granges-Paccot (CH)

(21) Appl. No.: 15/037,796

(22) PCT Filed: Oct. 31, 2014
(86) PCT No.: PCT/EP2014/073486

§ 371 Date: May 19, 2016

(30) Foreign Application Priority Data
Nov. 21, 2013 (FR) 1361451

(51) Int. Cl. B60C 19/00; B60C 11/13

(52) U.S. Cl. CPC B60C 19/002; B60C 11/1307; B60C 2011/1338

(57) ABSTRACT

Disclosed herein is a tread for a tire, in which the tread provides an improvement to the resonance noise-reducing devices and seeks at the same time to obtain easy molding and demolding of the flexible blades that form the groove closure device and complete closure of the cross section of each groove in which these flexible blades are formed.

This application is a 371 national phase entry of PCT/EP2014/073486, filed 31 Oct. 2014, which claims the benefit of French Patent Application No. 1361451, filed 21 Nov. 2013, the contents of which are incorporated herein by reference for all purposes.

### BACKGROUND

The aspects disclosed herein relate to tire treads and more particularly to tire treads comprising grooves, the latter being provided with closure devices so as to reduce the noise generated by the air in these grooves going into resonance during running.

It is known that as each groove, notably grooves of circumferential overall orientation, enters the contact patch in which the tire is in contact with a roadway during running, air is made to circulate along these grooves. With the roadway each groove forms a pipe that has two open ends.

The air in this pipe forms a vibrating air column the resonant frequency of which is dependent on the length separating the two ends of the pipe and therefore on the length of groove affected by contact with the roadway.

This resonance of the air in the grooves has the effect of generating, in a vehicle fitted with these tires, a noise inside the vehicle and a noise outside the vehicle. These inside and outside noises usually correspond to a frequency of 1 kHz or thereabouts, which corresponds to a frequency to which the human ear is particularly sensitive.

In order to reduce such resonance noise, it is known practice (see for example patent document FR2715891), to arrange in each circumferentially oriented groove, or groove with a circumferential overall orientation, a plurality of relatively thin flexible blades or membranes made of rubber compound, each flexible blade or membrane occupying the entire cross section of the groove or at the very least a large proportion of this cross section so as to form a closure device.

Each flexible blade may extend from the bottom of the groove or may be fixed to at least one of the walls delimiting the said groove. Relatively thin here means that each flexible blade is able to flex in order to at least partially open the cross section of the groove under the effect of a flow of liquid notably when driving in the wet. These same blades remain in the position in which the groove is closed when driving in the dry.

By virtue of these flexible blades, the length of the air column in each circumferential groove is reduced by comparison with the overall length of groove in the contact patch, and in this results in a change in the resonant frequency. The shift in frequency is towards resonant frequency values to which the human ear is less sensitive.

Of course, in order to maintain the water drainage function needed when running on a wet roadway, notably when driving in the wet, it is absolutely essential that this membrane be able to flex appropriately under the action of the pressure of the water and thus at least partially open the cross section of the groove in order to allow a sufficient flow of liquid to circulate.

A block is a raised element formed on the tread and delimited by voids or grooves and comprising lateral walls and a contact face intended to come into contact with the roadway. This contact face has a geometric center defined as being the barycenter or center of gravity of the face.

A rib is a raised element formed on a tread, this element extending in the circumferential direction and making a complete circuit of the tire. A rib comprises two lateral walls and a contact face, the latter being intended to come into contact with the roadway during running.

A radial direction in this document means any direction which is perpendicular to the axis of rotation of the tire; this direction corresponds to the direction of the thickness of the tread.

A transverse or axial direction means a direction parallel to the axis of rotation of the tire.

A circumferential direction means a direction tangential to any circle centered on the axis of rotation. This direction is perpendicular both to the axial direction and to a radial direction.

Axially towards the outside means a direction oriented towards the outside of the internal cavity of the tire.

Equatorial plane: plane perpendicular to the axis of rotation and passing through the axially outermost points of the tire, this equatorial plane dividing the tire into two substantially equal halves.

The usual running conditions of the tire or conditions of use are those defined by the E.T.R.T.O. standard; these conditions of use specify the reference inflation pressure corresponding to the load bearing capacity of the tire as indicated by its load rating and speed code. These conditions of use may also be referred to as “nominal conditions” or “usual conditions”.

A cut generally denotes either a groove or a sipe and corresponds to the space delimited by the walls of material facing one another and distance from one another by a non-zero distance (referred to as the “width of the cut”). It is precisely this distance that differentiates a sipe from a groove; in the case of a sipe, this distance is suited to allowing the opposing walls delimiting the said sipe to come at least partially into contact at least in the contact patch. In the case of a groove, the walls of this groove cannot come into contact with one another under normal running conditions.

The tread surface of a tread corresponds to the surface of the tread that comes into contact with the ground when a tire provided with such a tread is being driven on.

As was recalled earlier, the devices formed of flexible blades and described in the prior art—on account of the need to be able to flex under a flow of liquid—are connected either to the bottom of a groove or to one of the lateral walls delimiting a groove. However, a space remains either between the walls and each blade or between the bottom and each blade, thereby reducing the expected resonance noise reduction performance.

In order to address this problem, an earlier patent application, not yet published at the date of filing of the present application, has proposed forming small cuts or grooves in the bottom of a groove and on the walls delimiting this groove so that a blade can be inserted into these small cuts, thereby obtaining complete closure of the groove. While this solution is effective because it allows the groove to be completely closed, it nevertheless remains expensive to implement.

Document JP-H04 221207 A discloses a device comprising two disjointed blades, each blade being fixed to one wall and partially to the bottom of one and the same groove. There still remains between these two blades a space which is not closed and the noise performance can therefore be improved further.

There is a need to obtain a device that reduces resonance noise in the grooves that is simpler to implement and more economical.

The expression “wall bearing a blade” is to be interpreted in the present document as meaning one or other of the lateral walls delimiting a groove, the blade forming the noise-reducing device being secured to each lateral wall and to the bottom of the groove.

### SUMMARY

The present disclosure is an improvement to the resonance noise reducing devices and seeks at the same time to obtain easy molding and demolding of the flexible blades that form the groove closure device and complete closure of the cross section of each groove in which these flexible blades are formed.

To this end, the subject of the disclosure is a tire tread, this tread having a tread surface intended to come into contact with a roadway and comprising at least one groove of width W and of depth P delimited by two lateral walls facing one another, these lateral walls being joined together by a groove bottom, at least one groove comprising a plurality of closure devices, each closure device being made up of a flexible blade to close this groove in a rest position to a degree of closure of at least 90%, each blade having a thickness E suited to allowing it to deform under the effect of a circulation of liquid in the groove.

This tread is such that this flexible blade is secured to the two lateral walls delimiting the groove and is secured to the bottom of this groove, and such that each flexible blade is dimensionally suited to be able, under the action of a flow of liquid, to deform elastically in the groove and towards the bottom of the said groove in order to reduce its degree of closure of the cross section of this groove to at most 40%.

A flexible blade is said to be secured to the walls and to the bottom of a groove when it is connected fixedly to these walls and to the bottom unlike the flexible blades employed in the prior art which are connected only to the bottom of a groove or alternatively to one of the walls of a groove. Under the action of a liquid flowing in the groove provided with a device according to the disclosure, the flexible blade flexes and, while remaining secured to the lateral walls and to the bottom, deploys allowing the flow of liquid to pass as a result of predetermined dimensions. When the flow of liquid is interrupted, the flexible blade reverts to its non-deformed initial position by virtue of the elastic return generated by the material of which the blade is made. In general, this material is the rubbery material of which the tread is made.

The degree of closure of a flexible blade here means the portion, expressed as a percentage, of the cross section of the groove provided with such a flexible blade. A degree of closure equal to 100% means that the cross section is completely closed by the flexible blade.

Obtaining a degree of closure at most equal to 40% when the flexible blade is subjected to the action of a flow of liquid means that 60% of the cross section is open and allows this liquid to circulate. This percentage is measured when the tire is new, which indeed corresponds to the state in which the greatest amount of resonance noise is generated.

For preference the degree of closure when the blade is deformed under the action of a flow of liquid is at most 30% and more preferably still 20%.

Advantageously, when the flexible blade is deformed, the degree of closure is as small as possible—which means to say as close as possible to 0%—so that the wet-running performance is maintained until the tire is fully worn down to the regulation tread wear limit.

When considering the length. L(h) of the flexible blade between two points at which this flexible blade is connected to the walls delimiting a groove, these two points being situated at the same height h measured with respect to the bottom of the groove (if the bottom is curved then the height h is considered with respect to the innermost point of the bottom when viewed in cross section), it is advantageous for this length L, and regardless of the height h, to be determined so that the flexible blade—under the effect of a flow of fluid—can deploy inside the groove and towards the bottom of this groove so as to reduce the degree of closure at most to 40% and, more preferably still, at most 30% or even 10%, or even 0%.

For preference, the flexible blade has a length L(h) for a height h which is chosen so as to satisfy the following relationship:

1.5*(W+h*3.14)≧L(h)≧0.8*(W+h*3.14).

More preferably still, the length L(h) of the flexible blade between two points at which this flexible blade is connected to the walls delimiting a groove, these two points being situated at the same height h measured with respect to the bottom of the groove, and regardless of the height h, satisfies the relationship:

1.2*(W+h*3.14)≧L(h)≧0.9*(W+h*3.14).

For preference, the flexible blade of the noise-reducing device is perpendicular to the main direction of the groove (this direction corresponds to the direction in which water flows when driving in the wet).

The total height of a flexible blade is denoted H: this height H corresponds to the length measured between the bottom of the groove and those points of connection to the lateral walls that are furthest from the bottom of the groove.

This noise-reducing device may of course be used with any type of groove, whether this be a groove of circumferential, transverse or oblique orientation.

In one alternative form, a noise-reducing device comprises a blade formed of a central part and, on each side of this central part, connecting parts for connecting with the lateral walls delimiting the groove, each connecting part comprising at least one fold.

In another alternative form, any line plotted on a flexible blade and connecting all the points situated at the same height h with respect to the bottom of the groove has a generic shape comprising at least two undulations. An undulation here means a shape diverging from the straight line connecting the two points of connection of the blade with the walls delimiting the groove at the height h. This undulation may take the form of a succession of segments forming a broken line.

The elastic nature of the material of each flexible blade also creates elastic return forces to ensure that the blade returns to its position in which the groove is closed when there is no longer any flow of liquid in the said groove.

The disclosure also relates to any tire provided with a tread comprising a noise reducing device formed of a flexible blade to close this groove in the rest position to a degree LS of closure which is equal to 90%, each blade having a thickness E suited to allowing it to deform under the effect of a circulation of liquid in the groove.

Further features and advantages of the disclosure will become apparent from the description given hereinafter with reference to the attached drawings which, by way of nonlimiting examples, show embodiments of the subject matter of the disclosure.

### BRIEF DESCRIPTION OF THE FIGURES

FIG. 1 shows an alternative form according to the disclosure of a noise-reducing device in the closed state for preventing air from circulating;

FIG. 2 shows the alternative form of FIG. 1 in a partially open position for allowing a liquid to flow;

FIG. 3 shows a cross section of the groove closed off by the closure device according to the alternative form shown in FIG. 1;

FIG. 4 shows a cross section of the groove which is partially open under the effect of a flow of liquid as shown in FIG. 2;

FIG. 5 shows a surface view of a second alternative form according to the disclosure of a closure device, this device being formed of a planar central part and of connecting parts for connecting with the lateral walls delimiting the groove that form folds;

FIG. 6 shows a surface view of the second alternative form according to the disclosure in a deployed position to open the cross section of the groove.

### DETAILED DESCRIPTION

In the figures that accompany this description, the same reference signs may be used to describe alternative forms of the disclosure where these reference signs refer to elements of a similar nature, whether this nature be structural or indeed functional.

FIG. 1 shows an alternative form according to the disclosure of a noise-reducing device in the closed state for preventing air from circulating.

This FIG. 1 shows a groove 2 of circumferential overall orientation formed on the tread 1 of a tire. This groove of width W is delimited by lateral walls 21, 22 of raised elements, these lateral walls facing one another being connected by a groove bottom 20. This groove 2 has a depth P, when new, that is to say prior to any running and therefore before any wear. The tread comprises a tread surface 10 intended to come into contact with the roadway during running.

Formed in this groove 2 are a plurality of devices that counter resonance noise, each device being made up of a blade 3 of flexible rubber of the same nature as the material of which the raised elements of the tread are made. This flexible blade 3 is secured to the lateral walls 21, 22 delimiting the groove and to the bottom 20 of the groove. Moreover, each flexible blade 3 in the rest position and when new closes the entire groove so as to prevent any circulation of air during running. Rest position here means a state of the tire that is not loaded in running.

In this alternative form, the flexible blade 3 is dimensioned so as to be able to flex under the action of pressure generated by a flow of liquid notably when running on a wet roadway.

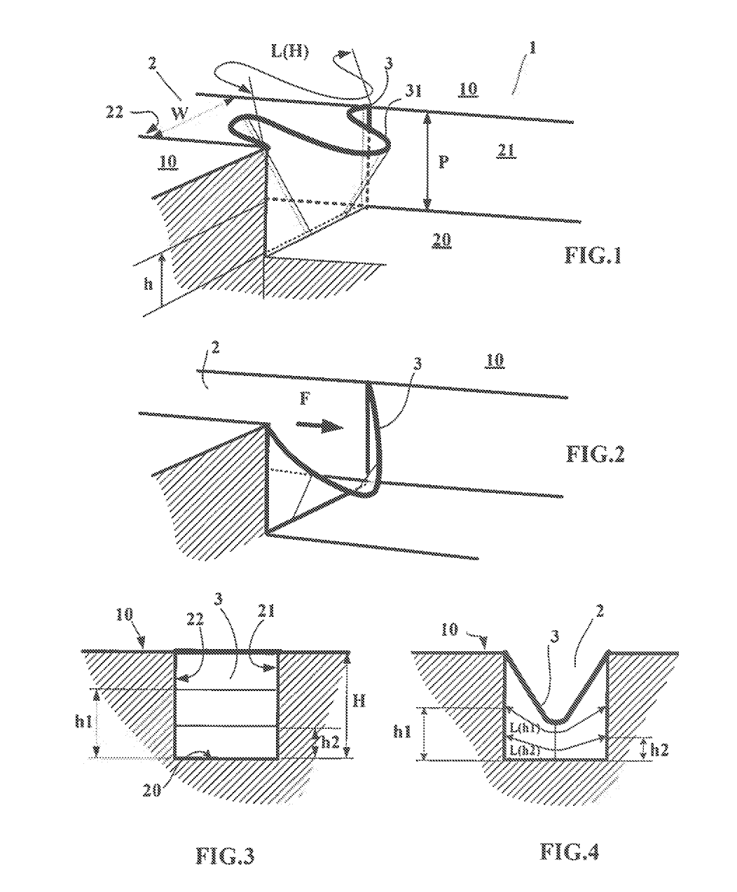

FIG. 2 shows the alternative form of FIG. 1 in a partially open position so as to allow the flow of a liquid indicted schematically by an arrow F. In this position, and when new, the cross section of the groove 2 is partially open (in this instance at least 60% of the cross section of the groove is open) so as to allow liquid to circulate when running on a wet roadway.

It is of course preferable for the flexible blade 3 in its open position for allowing liquid to circulate to close the cross section of the groove 2 in which it is placed as little as possible.

FIG. 3 shows a view in cross section of the groove 2 closed off by the closure device according to the alternative form depicted in FIG. 1.

It may be seen that the flexible blade 3 in its closed position is connected to each lateral wall 21, 22 delimiting the groove and to the bottom 20 of this groove. The flexible blade 3 has a total height H which in this instance is equal to the depth P of the groove when new. This flexible blade has a mean thickness of 2 millimeters.

In order to allow the blade 3 to flex in the groove and thus open the cross section of this groove, the lengths L(h1), L(h2) and L(H) each satisfy the following relationship:

1.5*(W+h*3.14)≧L(h)≧0.8*(W+h*3.14)

FIG. 4 shows a view in cross section of the groove 2 shown in FIG. 3 when liquid is flowing in this groove. Under the action of the pressure of the liquid circulating in the groove, the flexible blade 3 develops in the groove to open the cross section of the groove.

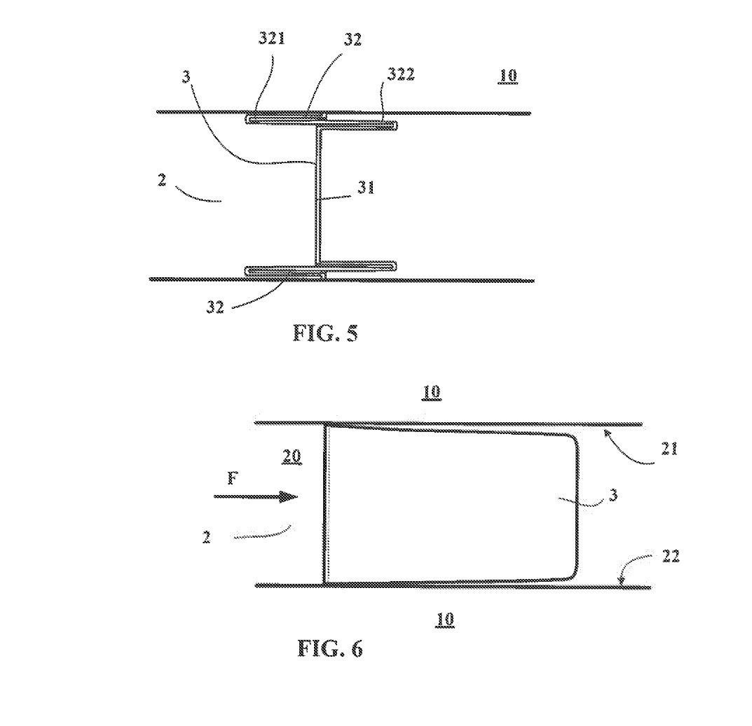

FIG. 5 shows a surface view of another alternative form according to the disclosure of a device for the closure of a groove (2) delimited by lateral walls 21, 22 intersecting the tread surface at edges and a groove bottom 20 connecting the said lateral walls. This closure device is formed of a flexible blade 3 comprising a planar central part 31 connected to the bottom 20 of the groove and, on each side of this central part 31, two connecting parts 32 securely connecting the flexible blade to the lateral walls delimiting the groove.

Each connecting part 32 forms two folds 321, 322 which are substantially parallel to the lateral walls 21, 22. The developed lengths of these connecting parts combined with the length of the central part are suited to allowing at least partial opening of the groove under the effect of a flow of liquid.

It is entirely possible to form just one fold or more than two folds for each connecting part provided that the condition whereby the length L(h) measured between two points of connection of this flexible blade to the walls delimiting a groove, these two points being) situated at the same height h measured with respect to the bottom of the groove, and whatever the height h, is chosen to satisfy the following relationship:

1.5*(W+h*3.14)≧L(h)≧0.8*(W+h*3.14),

is met,

W corresponding to the width of the groove on the tread surface when new.

FIG. 6 shows a surface view of the tread depicted in FIG. 5 in a configuration in which the flexible blade is deployed into the groove to open the cross section of this groove and allow liquid to circulate. In this configuration, the folds are unfolded so that the blade 3 can deploy into the groove and at least partially open the cross section.

While the disclosure has been described in general terms and using a number of alternative forms, it must be appreciated that this disclosure is not restricted to these alternative forms described and depicted alone. Notably, when the lateral walls delimiting a groove make an angle other than 90 degrees to the tread surface when new, it is easy for those skilled in the art to adapt the lengths L(h) of each blade to allow an opening of the cross section of the groove. Furthermore, the alternative forms described here may be combined with one another by those skilled in the art according to the objective being pursued, without departing from the scope of the disclosure as defined by the claims.

1. A tread for a tire, comprising:
a tread surface which comes into contact with a roadway, comprising
at least one groove of width W and of depth P delimited by two lateral walls facing one another, the two lateral walls being joined together by a groove bottom, with at least one groove comprising:
a plurality of closure devices, each of the plurality of closure device being made up of a flexible blade to close the at least one groove in a rest position to a degree of closure of at least 90%,
the flexible, blade having a thickness suited to allowing it to deform under the effect of a circulation of liquid in the at least one groove,
wherein the flexible blade is secured to the two lateral walls delimiting the groove and is secured to the bottom of the at least one groove, and
the flexible blade, under the action of a flow of liquid, deforms in the groove in order to reduce a degree of closure of the cross section of this groove to at most 40%,
the degree of closure being defined as a proportion of the cross section of the groove that is closed to the circulation of liquid.

2. The tread according to claim 1, wherein the degree of closure when liquid is flowing is at most 30%.

3. The tread according to claim 1, wherein a length L(h) of the flexible blade between two points at which this flexible blade is connected to the walls delimiting a groove, the two points being situated at a same height h measured with respect to the bottom of the groove, and regardless of the height h, is suited to the flexible blade—under the effect of a flow of fluid—being able to deploy inside the groove and towards the bottom of the groove so as to reduce the degree of closure, with the length L(h) satisfying the following relationship:
1.5*(W+h*3.14)≧L(h)≧0.8*(W+h*3.14).

4. The tread according to claim 1, wherein the length L(h) of the flexible blade between two points at which this flexible blade is connected to the walls delimiting a groove, these two points being situated at the same height h measured with respect to the bottom of the groove, and regardless of the height h, satisfies the relationship:
1.2*(W+h*3.14)≧L(h)≧0.9*(W+h*3.14).

5. The tread according to claim 1, wherein any line plotted on the flexible blade and connecting all the points situated at the same height h with respect to the bottom of the groove has a generic shape comprising at least two undulations.

6. The tread according to claim 1, wherein any line plotted on the flexible blade and connecting all the points situated at the same height h with respect to the bottom of the groove has a generic shape comprising at least one fold.

7. The tread according to claim 1, wherein the flexible blade comprises a planar central part and connecting parts connecting this central part on each side to the lateral walls delimiting the groove, each lateral part forming at least one fold substantially parallel to the said lateral walls.
